(19) United States
(12) Patent Application Publication
(10) Pub. No.: US 2007/0253151 A1
(43) Pub. Date: Nov. 1, 2007

(54) Panel display

(75) Inventor: Shu-Ju Liao, Taipei Hsien (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/785,850

(22) Filed: Apr. 20, 2007

(30) Foreign Application Priority Data
Apr. 21, 2006 (TW) 95114407

(51) Int. Cl. G06F 1/16

(52) U.S. Cl. 361/681

(57) ABSTRACT

A panel display includes a display panel, a T-shaped structure, and a base. The display panel is supported by the T-shaped structure, and the T-shaped structure is borne onto the base. The T-shaped structure includes a holding portion, an arm portion, and a slab portion. The holding portion, located on the arm portion, is used for holding the display panel. The slab portion is located below the arm portion. The base is formed with a guiding chute for receiving a portion of the arm portion and the slab portion to permit sliding of the T-shaped structure along a longitudinal direction of the guiding chute for changing the distance between the display panel and the base.

### BACKGROUND OF THE INVENTION

(1) Field of the Invention

The present invention relates to a panel display. More particularly, the invention relates to a panel display, by which a user may adjust the distance between the display panel and himself/herself easily.

(2) Description of the Prior Art

Please refer to FIG. 1, which illustrates a panel display 1 in the art. Generally, the panel display 1 is a liquid crystal display. The panel display 1 comprises a display panel 3, a supporter arm 4 and a base 5. The display panel 3 is disposed upon the base 5 through the supporter arm 4 as FIG. 1 shows. Generally, there's an adjustment (not shown in the figure) disposed between the display panel 3 and the supporter arm 4 for regulating rotation angles and pitch angles of the display panel 3 so as to match various needs of users.

However, the adjustment mentioned above can't respond to a user need of changing the distance between the display panel 3 and the user. If a user needs to change the distance between the display panel 3 and himself/herself, he/she has to move the panel display 1 so as to change its position. If the size of the panel display 1 is big, a problem arises that the panel display 1 may be too heavy to be moved. Additionally, changing the distance by moving the panel display 1 has another disadvantage that may damage the display panel 3 during the moving processes.

Due to disadvantages mentioned above, there comes a need to find out a convenient way for a user to adjust the distance between the display panel and the user.

### SUMMARY OF THE INVENTION

An object of the present invention is to provide a panel display having a guiding chute on the base thereof, so as to move the display panel thereof along the base easily.

Another object of the present invention is to provide a panel display which allows a user to adjust distances from the display panel thereof according to his/her needs.

In accordance with the present invention, the panel display includes a display panel, a T-shaped structure, and a base. The display panel is supported by the T-shaped structure, and the T-shaped structure is borne onto the base. The T-shaped structure includes a holding portion, an arm portion, and a slab portion. The holding portion, located on the arm portion, is used for holding the display panel. The slab portion is located below the arm portion. The base is formed with a guiding chute for receiving a portion of the arm portion and the slab portion to permit sliding of the T-shaped structure along a longitudinal direction of the guiding chute of the base, and thereby changing the distance between the display panel and the base can be achieved.

In one embodiment of the present invention, the panel display further provides a first bearing structure to let the T-shaped structure borne onto the base.

In one embodiment of the present invention, the panel display provides a second bearing structure to let the T-shaped structure borne onto the base.

In one embodiment of the present invention, the panel display provides a third bearing structure to let the T-shaped structure borne onto the base.

Preferably, the panel display can provide a first bearing structure, a second bearing structure and a third bearing structure to let the T-shaped structure borne onto the base.

In one embodiment of the present invention, the panel display provides a screw bar. By rolling the screw tick, the T-shaped structure can move along the guiding chute.

In one embodiment of the present invention, the panel display provides a torque equilibrium mode to improve the stability of the display panel while in moving along the base.

### BRIEF DESCRIPTION OF THE DRAWINGS

Other features and advantages of this invention will become more apparent in the following detailed description of the preferred embodiments of this invention, with reference to the accompanying drawings, in which:

FIG. 1A illustrates a panel display 1 in the art;

FIG. 2 shows perspective a first embodiment of the panel display according to the present invention;

FIG. 3A is a cross-section view of FIG. 2 along line a-a;

FIG. 3B is a cross-section view Of FIG. 2 along line b-b;

FIG. 4A illustrates a second embodiment of the panel display in accordance with the present invention;

FIG. 4B illustrates a bearing structure 223 of a third embodiment of the panel display in accordance with the present invention;

FIG. 4C illustrates a fourth embodiment of the panel display in accordance with the present invention;

FIG. 5 illustrates a fifth embodiment of the panel display in accordance with the present invention;

FIG. 6A shows a front side view of a switch mechanism for the panel display of the present invention;

FIG. 6B shows a lateral view of FIG. 6A; and

FIG. 7 illustrates schematically a typical panel display.

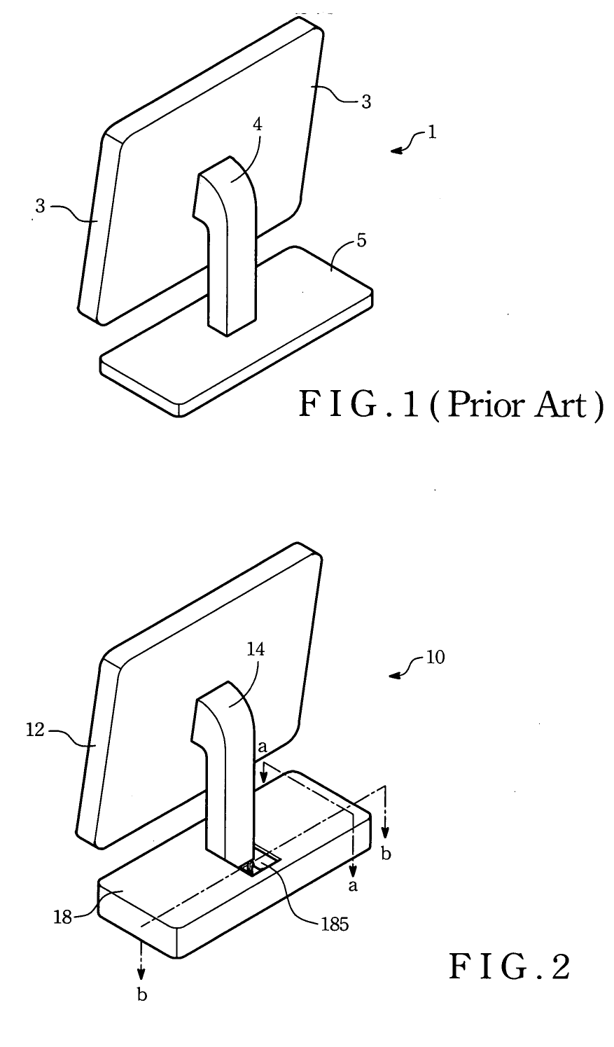

### DESCRIPTION OF THE PREFERRED EMBODIMENT

Please refer to FIG. 2, which shows a first embodiment of the panel display 10 according to the present invention. The panel display 10 comprises a display panel 12, a T-shaped structure 14 and a base 18. The T-shaped structure 14 is used for supporting the display panel 12, and the base 18 is used for bearing the T-shaped structure 14. Herein, the type of the panel display 10 is variable. It can be a liquid crystal display (LCD), a Plasma Display Panel (PDP), an organic light-emitting diode display (OLED display) or a surface conduction electron emitter display (SED).

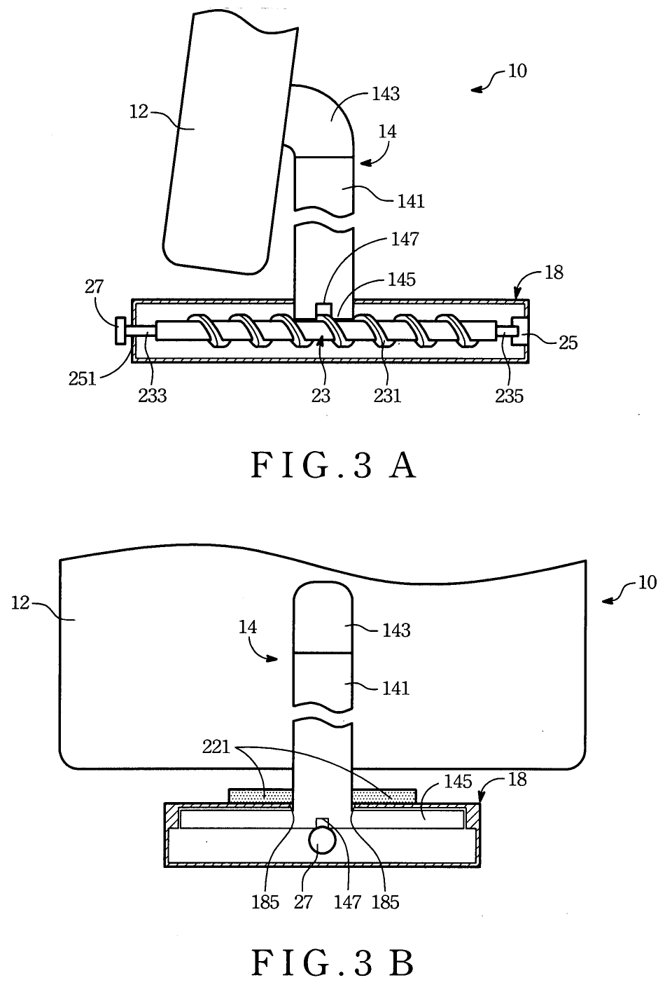

Further refer to FIG. 3A and FIG. 3B, which are two cross-section views of FIG. 2 along lines a-a and b-b, respectively. The T-shaped structure 14 further comprises an arm portion 141, a holding portion 143 disposed on a second (upper) side of the arm portion 141, and a slab portion 145 disposed on a first (lower) side of the arm portion 141. The holding portion 143 connects the display panel 12. The T-shaped structure 14 further comprises a bearing structure 221 that extends from the arm portion 141 as a collar shape so as to help the T-shaped structure 14 disposed steadily on the base 18.

The base 18 of the panel display 10 is formed with a guiding chute 185 for receiving a portion of the arm portion 141 and the slab portion 145. Hence, the T-shaped structure 14 may slide along a longitudinal direction of the guiding chute 185 of the base 18, and thereby the distance between the display panel 12 and a user can be adjusted by sliding the T-shaped structure 14 along the guiding chute 185.

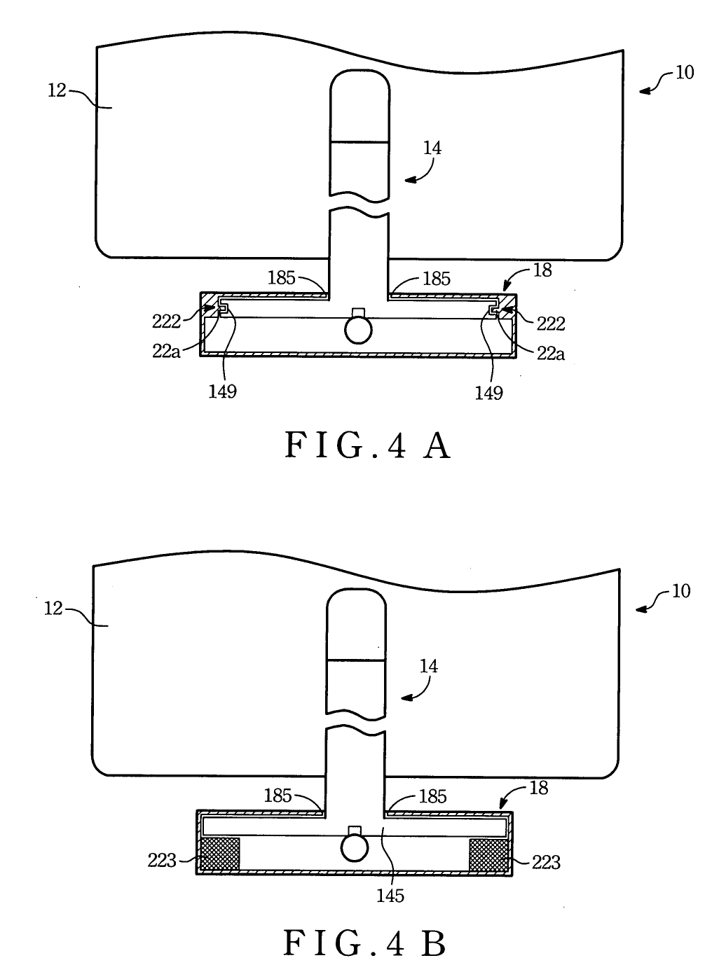

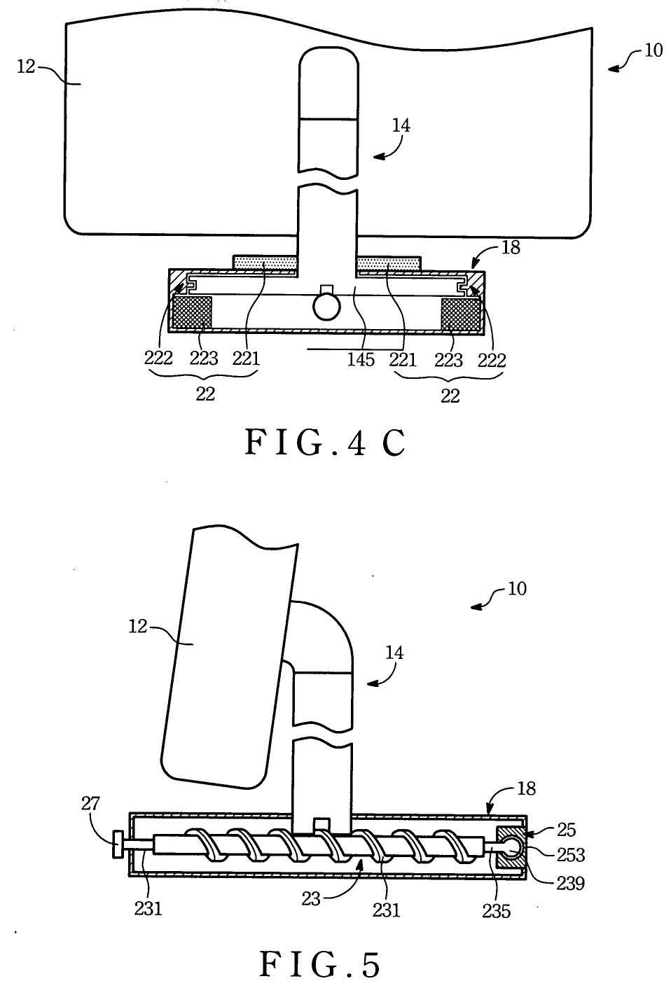

Referring to FIG. 4A, which is the second embodiment of the panel display in accordance with the present invention. The bearing structure of this embodiment is different from the last one of FIG. 3B. In FIG. 4A, the T-shaped structure 14 comprises a bearing structure 222, which is formed as an interior flange 22a of the base 18 extending inward from a lateral side of the base 18, while a corresponding lateral side of the slab portion 145 provides a pit 149 complementary to the flange 22a. Upon such an arrangement, a good match between the flange 22a and the pit 149 can make the T-shaped structure 14 borne steadily onto the base 18. Herein, the pair of the flange 22a and the pit 149 is only one of various pairs that can provide a fair match in between. In another embodiment of the present invention not shown in the figure, the flange may be formed at the slab portion, while the pit is formed at the base.

Please refer to FIG. 4B, which shows a bearing structure 223 of the third embodiment of the panel display in accordance with the present invention. The base 18 comprises a bearing structure 223 disposed under the slab portion 145, so as to make the T-shaped structure 14 borne onto the base 18 well.

Please refer to FIG. 4C, which shows the fourth embodiment of the panel display in accordance with the present invention. The bearing structure 22 of this embodiment comprises integrally the bearing structure 221 in FIG. 3B, the bearing structure 222 in FIG. 4A and the bearing structure 223 in FIG. 4B, for firmly making the T-shaped structure 14 borne onto the base 18.

Referring back to FIG. 3A and FIG. 3B again, the base 18 further comprises a screw bar 23 which has a thread 231, and the screw bar 23 is disposed under the slab portion 145. The slab portion 145 having a through 147 meshed with the thread 231. By rolling the screw bar 23, the T-shaped structure 14 can then move back and forth along the guiding chute 185. The movement of the T-shaped structure 14 enables the display panel 12 to change positions on the base 18, and thereby the distance between the display panel 12 and a user can be changed as well (if the base 18 is fixed in position).

Furthermore, the screw bar 23 can include a first extending part 233 at one end and a second extending part 235 at another end. The first extending part 233 extends to pass through a hole 251 of the base 18, and the second extending part 235 extends to be rotationally mounted onto a support 25 of the base 18. Upon such an arrangement, the screw bar 23 can rotate under the slab portion 145 to drive the T-shaped structure 14. Herein, the support 25 can be a sleeve.

Please refer to FIG. 5, which is a fifth embodiment of the panel display in accordance with the present invention. Herein, the support 25 formed as a housing of a ball-shape pivotal joint comprises a globe concave 253, while the second extending part 235 is formed to have an globe structure 239. The ball-shape pivotal joint is formed by lodging the globe structure 239 into the globe concave 253 so as to make the screw bar 23 pivotal to the support 25. In some embodiments, the thread 231, the first extending part 233, the second extending part 235 and the globe structure 239 can be manufactured in a unique piece.

Referring to FIG. 3A and FIG. 3B again, the base 18 further comprises a pivot handle 27 connecting to the first extending part 233, the pivot handle 27 can be turned to drive the screw bar 23 directly, and then to further move the display panel 12 along the base 18 due to the mesh motion between the thread 231 and the through 147 of the slab portion 145. The pivot handle 27 facilitates the moving of the display panel 12 to a great extent of the panel weight.

For a forcing and efficient reason, the adjustment of the pivot handle 27, however, can only provide a limited moving range of the display panel 12, and thus is defined as a fine tuning operation. The panel display of the present invention further has another adjustment mode to move the display panel 12 along the base 18 at a bigger scale. In this adjustment mode, the through 147 of the slab portion 145 may be separated or lifted temporarily from the thread 231 of the screw bar 23 so as to let the display panel 12 shift directly and swiftly to another position on the base 18 through the guiding chute 185, and then the through 147 and the thread 231 are re-engaged.

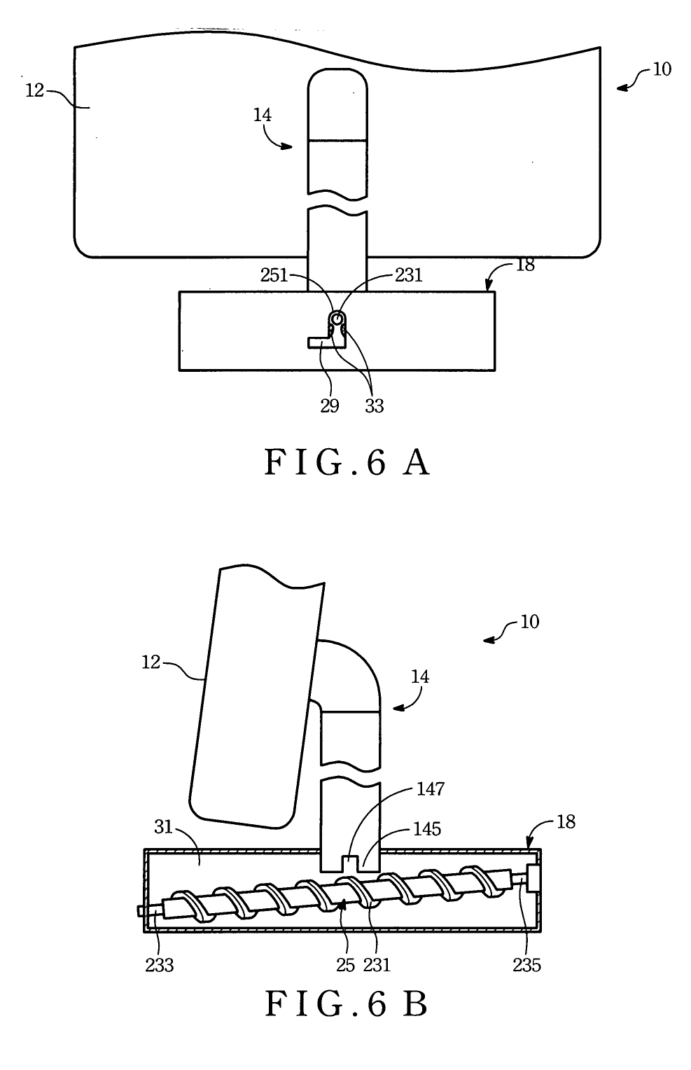

FIG. 6A shows a front side view of the switch mechanism of the panel display 10, and FIG. 6B shows the lateral view of the switch mechanism of the panel display 10. Herein, the pivot handle 27 is not shown for conveniently illustrating the switch mechanism of the present invention. The base 18 further comprises a switch mechanism including at least a penetrating through 29 and an interior switch space 31. The penetrating through 29 is adjacent to and communicated in space with the hole 251, and the switch space 31 is an allowable space for the screw bar 23 to shift in response to an end location change of the screw bar 23 between the penetrating through 29 and the hole 251. The first extending part 233 may move along the penetrating through 29 so as to disengage the thread 231 of the screw bar 23 from the through 147 of the slab portion 145, and thus to let the T-shaped structure 14 able to move swiftly along the guiding chute 185. By providing the switch mechanism and the pivotal handle 27 to the present invention, a user can move the display panel 12 swiftly along the base 18 at a large scale, and then fine tune it through the pivot handle 27.

Additionally, the switch mechanism further comprises an elastic jam structure 33. The jam structure 33 is disposed on the internal walls of the penetrating through 29 to avoid the first extending part 233 falling freely into the penetrating through 29 due to its own weight. However, a user may exert a downward pressure upon the first extending part 233 to fall into the penetrating through 29 from the hole 251 by overcoming the resistance of the jam structure 33. Similarly, a user may exert an upward pressure upon the first extending part 233 to force it back to the hole 251 from the penetrating through 29.

The panel display 10 of the present invention can further have another way to move the display panel 12 along the base 18. The base 18 may further comprise an electric motor (not shown in figures) pivotally connecting to the first extending part 233 or the second extending part 235 of the screw bar 25. The electric motor may drive the screw bar 25 so as to make the display panel 12 move along the base 18. A user can only switch on the electric motor through an outer switch button to move the display panel 12 with respect to the base 18.

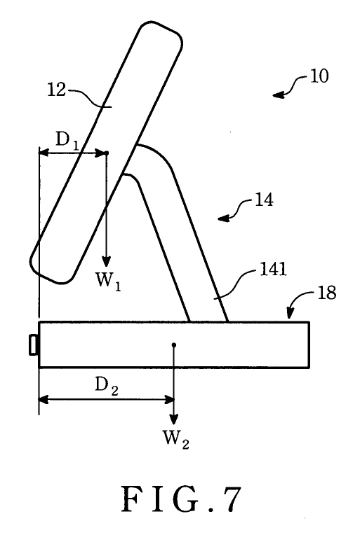

Moreover, to prevent from the problem that the weight of the display panel 12 may topple down the display panel 12 while in moving along the base 18, a simple torque equilibrium criterion is also provided. Please refer to FIG. 7, which shows schematically a panel display. Herein, a weight of the display panel 12 is defined as W1, a horizontal distance between a center of gravity of the display panel 12 and a front end of the base 18 is defined as D1, a weight of the base 18 is defined as W2, and a horizontal distance between a center of gravity of the base 18 and the front end of the base 18 is defined as D2. Then, the condition not to topple down the display panel 12 (i.e. that can move the display panel 12 stably on the base 18) is W1*D1<W2*D2.

By providing the present invention, the distance between the display panel and the user is easy to be both tuned in a large scale and fine tuned, such that the possibility of toppling down the display panel during its position adjustment can be substantially lowered and thus the possible cost accounting to the aforesaid toppling down can be also reduced to a minimum.

While the present invention has been particularly shown and described with reference to such preferred embodiments, it will be understood by those skilled in the art that various changes in form and detail may be without departing from the spirit and scope of the present invention.

What is claimed is:

1. A panel display comprising:
a display panel;
a T-shaped structure for supporting the display panel, further comprising:
an arm portion;
a slab portion disposed on a first side of the arm portion; and
a holding portion disposed on a second side of the arm portion for holding the display panel; and
a base for bearing a weight of the T-shaped structure, having a guiding chute for receiving a portion of the arm portion and the slab portion so as to allow the T-shaped structure to slide along a longitudinal direction of the guiding chute of the base.

2. The panel display of claim 1, wherein the T-shaped structure further comprises a first bearing structure extending from the arm portion and disposed on the base so as to let the T-shaped structure borne onto the base.

3. The panel display of claim 1, wherein the T-shaped structure further comprises a second bearing structure formed as an interior flange of the base extending inward from a lateral side of the base, and a lateral side of the slab portion has a pit complementary to the flange.

4. The panel display of claim 1, wherein the base further comprises a third bearing structure disposed under the slab portion so as to make the T-shaped structure borne onto the base well.

5. The panel display of claim 1, wherein the base further comprises a screw bar having a thread disposed under the slab portion, the slab portion having a through meshed with the thread.

6. The panel display of claim 5, wherein the screw bar further includes a first extending part at one end thereof and a second extending part at another end thereof, the first extending part passing through a hole of the base, and the second extending part rotationally mounted on a support of the base.

7. The panel display of claim 6, wherein the base further comprises an electric motor coupling to the screw bar for driving the screw bar to move the display panel therealong.

8. The panel display of claim 6, wherein the base further comprises a pivot handle connected to the first extending part, for being turned to further drive the screw bar.

9. The panel display of claim 8, wherein the base further comprises a switch mechanism including a penetrating through and a switch space, the penetrating through is adjacent to and communicated in space with the hole, and the switch space is an allowable space for the screw bar; in the case that the first extending part moves to the penetrating through, the thread of the screw bar disengaging the through of the slab portion.

10. The panel display of claim 1, wherein the panel display is selected from a group consisted of liquid crystal displays (LCD), Plasma Display Panels (PDP), organic light-emitting diode displays (OLED display) or surface conduction electron emitter displays (SED).

11. A panel display comprising:
a display panel;
a T-shaped structure for supporting the display panel, further comprising:
an arm portion;
a slab portion having a through disposed on a first side of the arm portion; and
a holding portion disposed on a second side of the arm portion for holding the display panel; and
a base for bearing a weight of the T-shaped structure, comprising screw bar having a thread disposed under the slab portion,
wherein, the through is meshed with the thread, and the T-shaped structure can then move back and forth along the screw bar by rolling the screw bar.

12. The panel display of claim 11, wherein the base has a guiding chute for receiving a portion of the arm portion and the slab portion so as to allow the T-shaped structure to slide along a longitudinal direction of the guiding chute of the base.

13. The panel display of claim 12, wherein the screw bar further includes a first extending part at one end thereof and a second extending part at another end thereof, the first extending part passing through a hole of the base, and the second extending part rotationally mounted on a support of the base.

14. The panel display of claim 13, wherein the base further comprises an electric motor coupling to the screw bar for driving the screw bar to move the display panel therealong.

15. The panel display of claim 13, wherein the base further comprises a pivot handle connected to the first extending part, for being turned to further drive the screw bar.

16. The panel display of claim 15, wherein the base further comprises a switch mechanism including a penetrating through and a switch space, the penetrating through is adjacent to and communicated in space with the hole, and the switch space is an allowable space for the screw bar; in the case that the first extending part moves to the penetrating through, the thread of the screw bar disengaging the through of the slab portion.

17. The panel display of claim 16, wherein the T-shaped structure further comprises a first bearing structure extending from the arm portion and disposed on the base so as to let the T-shaped structure borne onto the base.

18. The panel display of claim 16, wherein the T-shaped structure further comprises a second bearing structure formed as an interior flange of the base extending inward from a lateral side of the base, and a lateral side of the slab portion has a pit complementary to the flange.

19. The panel display of claim 16, wherein the base further comprises a third bearing structure disposed under the slab portion so as to make the T-shaped structure borne onto the base well.

20. The panel display of claim 10, wherein the panel display is selected from a group consisted of liquid crystal displays (LCD), Plasma Display Panels (PDP), organic light-emitting diode displays (OLED display) or surface conduction electron emitter displays (SED).
